(19) United States
(12) Patent Application Publication
(10) Pub. No.: US 2004/0073610 A1
(43) Pub. Date: Apr. 15, 2004

(54) Contents reproducing system

(76) Inventors: Katsuhiko Terada, Yokohama-shi (JP); Yoshiaki Kakimura, Tokyo (JP); Ryo Hirayama, Tokyo (JP); Akinori Suyama, Fujisawa-shi (JP); Kazuyuki Miyauchi, Kawasaki-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/665,513

(22) Filed: Sep. 22, 2003

(30) Foreign Application Priority Data
Sep. 30, 2002 (JP) 2002-286237

(51) Int. Cl. G06F 15/16

(52) U.S. Cl. 709/203; 709/219

(57) ABSTRACT

A network connects first, second, and third apparatuses. The first apparatus generates a first list of contents represented by data stored therein. The second apparatus generates a second list of contents represented by data stored therein. The first apparatus gets the second list of contents from the second apparatus, and combines the first list of contents and the second list of contents into a third list of contents. The second apparatus gets the first list of contents from the first apparatus, and combines the first list of contents and the second list of contents into a fourth list of contents which is equal to the third list of contents. The third apparatus refers to one of (1) the third list of contents which is generated by the first apparatus and (2) the fourth list of contents which is generated by the second apparatus.

### BACKGROUND OF THE INVENTION

1. Field of the Invention

This invention relates to a contents reproducing system and a contents recording and reproducing system such as those of home-use types. In addition, this invention relates to a system for reproducing or recording and reproducing contents data such as moving picture data (MPEG2 data), still picture data (Bmap data), and audio data (MP3 data). Furthermore, this invention relates to a home-use system in which a plurality of apparatuses storing respective contents data are connected by a network, and desired one of the contents represented by the data can be reproduced by desired one of the apparatuses.

2. Description of the Related Art

In a known system, a plurality of apparatuses storing respective contents data are connected by a network, and one of the apparatuses can get content data from another apparatus and then reproduce the content represented by the data. The known system includes a display which indicates a contents list, that is, a list of contents represented by the data stored in the apparatuses. In the case of audio contents, an example of the contents list is a list of tune names. Desired one of the contents can be designated by referring to the contents list, and then the designated content can be reproduced.

Japanese patent application publication number P2002-83485A discloses an AV network system in which a set top box, video data recording and reproducing apparatuses, disc drives, a home server, and a display are connected by an IEEE1394 network. Examples of the recording and reproducing apparatuses are a digital camera, a digital video recorder, and a digital VTR. Examples of the disc drives are a CD drive, an MD drive, and a DVD drive. The home server stores contents data. The home server holds first information representing the attributes of the contents represented by the stored data. The home server collects, from the recording and reproducing apparatuses and the disc drives, second information representing the attributes of the contents represented by data stored in the recording and reproducing apparatuses and data stored in recording mediums set within the disc drives. The home server gets third information representing the relation between the contents data and the apparatuses and disc drives. On the basis of the first information, the second information, and the third information, the home server generates a signal representative of a list of the contents represented by the data stored therein, the data stored in the recording and reproducing apparatuses, and the data stored in the recording mediums within the disc drives. The display is fed with the contents list signal and is controlled by the home server to indicate the contents list represented by the signal. The indicated contents list shows the attributes of each of the contents. For example, the contents list shows the genre and title, the date, and the recording time of each of the contents. Furthermore, the contents list shows which of the homer server, the recording and reproducing apparatuses, and the disc drives data representing each of the contents are stored in.

There is a known CD or DVD player having a bookmark providing function which is designed as follows. In the case where the reproduction of a content is suspended and a power supply to the player is cut off, the bookmark providing function automatically loads a memory with bookmark information indicating the specified position in the content at which the reproduction thereof is suspended. When the reproduction of the same content is requested again, the bookmark providing function retrieves the bookmark information and restarts the reproduction thereof from the specified position (the reproduction suspension place). In this way, the rest of the content is automatically reproduced.

Japanese patent application publication number P2002-44586A discloses a video data recording and reproducing apparatus including a bookmark adding button for a bookmark providing function. The apparatus in Japanese application P2002-44586A is designed as follows. During the reproduction of a video content, when the bookmark adding button is depressed, the apparatus generates a bookmark information piece. The bookmark information piece includes an ID signal for the content, and also a position signal representing a desired reproduction start place in the content which corresponds to the moment of the depression of the bookmark adding button. The apparatus stores the bookmark information piece into a recording device such as a magnetic hard disk, a recordable DVD, or a non-volatile memory. Specifically, the apparatus registers the bookmark information piece in a bookmark list provided in the recording device. The bookmark list is able to have bookmark information pieces relating to different contents respectively. The bookmark list is indicated by a display. When one is selected from the bookmark information pieces in the indicated list, the apparatus identifies a content in accordance with the ID signal in the selected bookmark information piece. Then, the apparatus starts the reproduction of the identified content from the desired reproduction start place indicated by the position signal in the selected bookmark information piece.

In the system of Japanese application P2002-83485A, the contents list shows the attributes of contents in groups assigned to the homer server, the recording and reproducing apparatuses, and the disc drives respectively. Thus, as the number of the homer server, the recording and reproducing apparatuses, and the disc drives increases, it takes a longer time to select one among the contents by referring to the contents list.

The bookmark providing function disclosed in Japanese application P2002-44586 is designed for a single apparatus, and is unsuited to a contents reproducing system including a plurality of apparatuses connected by a network.

### SUMMARY OF THE INVENTION

It is a first object of this invention to provide an improved contents reproducing system.

It is a second object of this invention to provide an improved contents recording and reproducing system.

A first aspect of this invention provides a contents reproducing system comprising first, second, and third apparatuses; a network connecting the first, second, and third apparatuses; means provided in the first apparatus for generating a first list of contents represented by data stored in the first apparatus; means provided in the second apparatus for generating a second list of contents represented by data stored in the second apparatus; means provided in the first apparatus for getting the second list of contents from the second apparatus and combining the first list of contents and the second list of contents into a third list of contents; means provided in the second apparatus for getting the first list of contents from the first apparatus and combining the first list of contents and the second list of contents into a fourth list of contents which is equal to the third list of contents; and means provided in the third apparatus for referring to one of (1) the third list of contents which is generated by the first apparatus and (2) the fourth list of contents which is generated by the second apparatus.

A second aspect of this invention is based on the first aspect thereof, and provides a contents reproducing system further comprising means provided in the first apparatus for, when data representing a first new content is stored in the first apparatus, updating the first list of contents to include the first new content; means provided in the second apparatus for, when data representing a second new content is stored in the second apparatus, updating the second list of contents to include the second new content; means provided in the first apparatus for updating the third list of contents in response to the updating of the first list of contents and the updating of the second list of contents; and means provided in the second apparatus for updating the fourth list of contents in response to the updating of the first list of contents and the updating of the second list of contents.

A third aspect of this invention is based on the first aspect thereof, and provides a contents reproducing system further comprising means provided in the first apparatus for, when the second apparatus is disconnected from the network, updating the third list of contents to delete therefrom the contents represented by the data stored in the second apparatus; and means provided in the second apparatus for, when the first apparatus is disconnected from the network, updating the fourth list of contents to delete therefrom the contents represented by the data stored in the first apparatus.

A fourth aspect of this invention provides a contents reproducing system comprising a first reproducing apparatus; a second reproducing apparatus; a network connecting the first reproducing apparatus and the second reproducing apparatus; first means for, when the first reproducing apparatus suspends reproduction of a content and there occurs an un-reproduced part of the content, generating first information to identify the content, second information to identify a place storing data representing the content, and third information indicating a bookmark point corresponding to a beginning of the un-reproduced part of the content; and second means for, when the un-reproduced part of the content is requested to be reproduced by the second reproducing apparatus, causing the second reproducing apparatus to identify the content in response to the first information, to get the data representing the identified content from the place identified by the second information, and to reproduce the un-reproduced part of the content in response to the bookmark point indicated by the third information.

A fifth aspect of this invention is based on the fourth aspect thereof, and provides a contents reproducing apparatus further comprising a content bookmark button provided in the first reproducing apparatus; third means for causing the first reproducing apparatus to suspend the reproduction of the content when the content bookmark button is actuated; and fourth means for activating the first means when the content bookmark button is actuated.

A sixth aspect of this invention is based on the fourth aspect thereof, and provides a contents reproducing apparatus further comprising a memory provided in the first reproducing apparatus; third means for combining the first information, the second information, and the third information into bookmark information; fourth means for writing the bookmark information into the memory; and fifth means for transmitting the bookmark information to the second reproducing apparatus.

A seventh aspect of this invention provides a contents recording and reproducing system comprising first, second, and third apparatuses; a network connecting the first, second, and third apparatuses; means provided in the first apparatus for generating a first list of contents represented by data stored in the first apparatus; means provided in the second apparatus for generating a second list of contents represented by data stored in the second apparatus; means provided in the first apparatus for getting the second list of contents from the second apparatus and combining the first list of contents and the second list of contents into a third list of contents; means provided in the second apparatus for getting the first list of contents from the first apparatus and combining the first list of contents and the second list of contents into a fourth list of contents which is equal to the third list of contents; and means provided in the third apparatus for referring to one of (1) the third list of contents which is generated by the first apparatus and (2) the fourth list of contents which is generated by the second apparatus.

An eighth aspect of this invention provides a contents recording and reproducing system comprising a first reproducing apparatus; a second reproducing apparatus; a network connecting the first reproducing apparatus and the second reproducing apparatus; first means for, when the first reproducing apparatus suspends reproduction of a content and there occurs an un-reproduced part of the content, generating first information to identify the content, second information to identify a place storing data representing the content, and third information indicating a bookmark point corresponding to a beginning of the un-reproduced part of the content; and second means for, when the un-reproduced part of the content is requested to be reproduced by the second reproducing apparatus, causing the second reproducing apparatus to identify the content in response to the first information, to get the data representing the identified content from the place identified by the second information, and to reproduce the un-reproduced part of the content in response to the bookmark point indicated by the third information.

### BRIEF DESCRIPTION OF THE DRAWINGS

FIG. 1 is a diagram of a contents reproducing system or a contents recording and reproducing system according to an embodiment of this invention.

FIG. 2 is a block diagram of a portion of a server in FIG. 1.

FIG. 3 is a block diagram of a portion of a client in FIG. 1.

FIG. 4 is a diagram of an example of an apparatus list.

FIG. 5 is a diagram of an example of a contents list in a first server in FIG. 1.

FIG. 6 is a diagram of an example of a contents list in a second server in FIG. 1.

FIG. 7 is a diagram of a correspondence relation among the title of a content, the address of a place or an apparatus storing a file of the content, and added information representing the name of a singer relating to the content and the genre of the content.

FIG. 8 is a diagram of a portion of the system in FIG. 1 and signals transmitted among servers and clients.

FIG. 9 is a diagram of an example of a list of all contents.

FIG. 10 is a diagram of a reproducible contents menu (an all contents list) indicated on a display of a server in FIG. 1.

FIG. 11 is a diagram of an example of a portion of an all contents list which is indicated on a display of a client in FIG. 1.

FIG. 12 is a diagram of a first example of a hierarchical contents list in servers in FIG. 1.

FIG. 13 is a diagram of pictures successively indicated on a display of a client in FIG. 1 and corresponding to respective unit portions of a hierarchical contents list.

FIG. 14 is a diagram of a second example of the hierarchical contents list in servers in FIG. 1.

FIG. 15 is a diagram of bookmark areas of a memory which are assigned to respective bookmark signals in each of servers, clients, and a portable digital assistant in FIG. 1.

FIG. 16 is a plan view of a portion of a remote control unit in a server in FIG. 1.

FIG. 17 is a diagram of a portion of the system in FIG. 1 and signals transmitted among servers, clients, and a portable digital assistant.

FIG. 18 is a time-domain diagram of reproduction of a first part of a content by a server in FIG. 1 and reproduction of a subsequent part of the content by a client in FIG. 1.

FIG. 19 is a flowchart of a segment of a control program for a server in FIG. 1 which relates to the generation and updating of a contents list.

FIG. 20 is a flowchart of a segment of a control program for a server in FIG. 1 which relates to the transmission of a contents list and the merger of contents lists.

FIG. 21 is a flowchart of a segment of a control program for a server in FIG. 1 which relates to the transmission of an all contents list.

FIG. 22 is a flowchart of a segment of a control program for a server, a client, or a digital portable assistant in FIG. 1 which relates to a bookmark providing function.

FIG. 23 is a flowchart of a segment of a control program for a server, a client, or a portable digital assistant in FIG. 1 which relates to the start of content reproduction responsive to a bookmark signal (bookmark information).

### DETAILED DESCRIPTION OF THE INVENTION

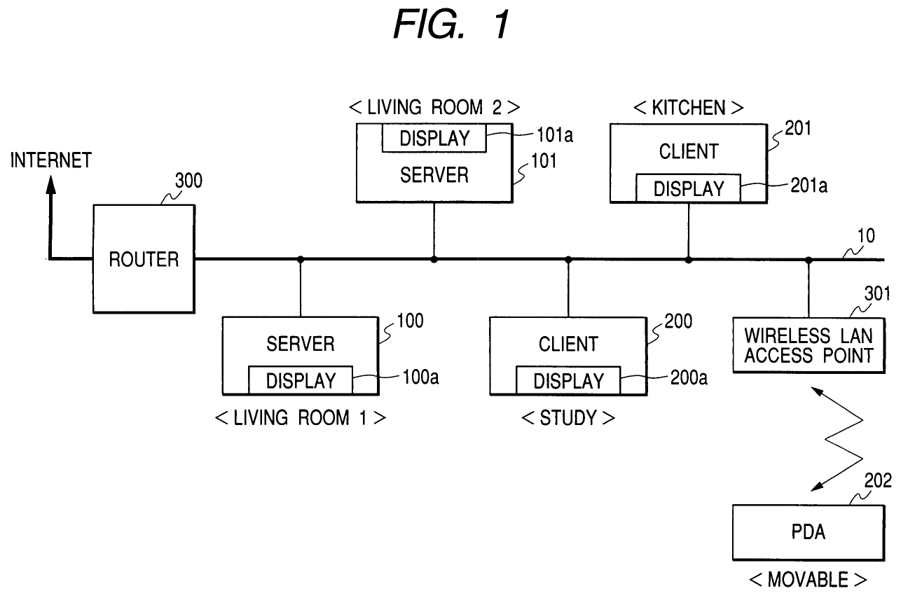

With reference to FIG. 1, a contents reproducing system or a contents recording and reproducing system of an embodiment of this invention includes servers 100 and 101, clients 200 and 201, and a personal digital assistant (PDA) 202 which are also referred to as apparatuses. The servers 100 and 101 operate as media banks. Each of the servers 100 and 101 includes a recording medium, and acts to record and reproduce contents data on and from the recording medium. Each of the servers 100 and 101 can provide contents data to a communication opposite party. The clients 200 and 201 are of a simple type such as a playback only type. Each of the clients 200 and 201 can reproduce a content or contents represented by data mainly provided by the server 100 or 101. The personal digital assistant 202 operates as a client for reproducing a content or contents represented by data mainly provided by the server 100 or 101. For example, the servers 100 and 101 and the clients 200 and 201 are located in different rooms of a house, respectively.

A network 10 connects the server 100 and 101 and the clients 200 and 201. The network 10 includes a wired LAN such as an Ethernet (trademark) or a wireless LAN conforming to the “802.11b” standards. The network 10 leads to a router 300 for connection with the Internet. A wireless LAN access point 301 is connected with the network 10. The personal digital assistant 202 includes a wireless communication unit. The personal digital assistant 202 can be connected with the network 10 via the wireless LAN access point 301.

The server 100 includes a display 100a. The server 101 includes a display 101a. The client 200 includes a display 200a. The client 201 includes a display 201a. The personal digital assistant 202 includes a display (not shown).

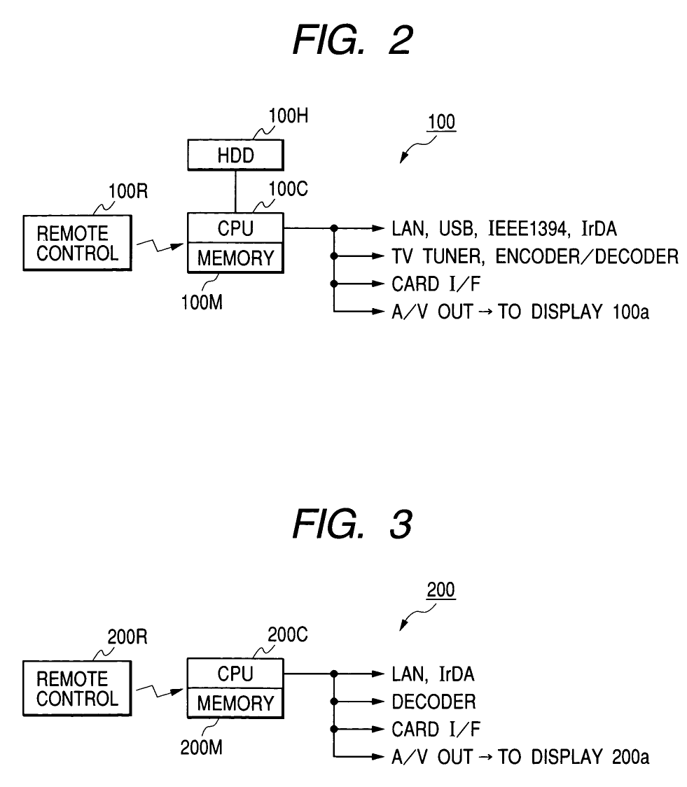

The servers 100 and 101 are similar in structure. Only the server 100 will be described below in more detail. As shown in FIG. 2, the server 100 includes a CPU 100C, a memory 100M, and a hard disk drive 100H. The memory 100M and the hard disk drive 100H are connected with the CPU 100C. The hard disk drive 100H contains a recording medium (a hard disk) therein. The server 100 further includes encoders/decoders for different signal formats, input/output portions of LAN, USB, IEEE1394, and IrDA types, an interface for a memory card, input/output devices for audio/visual (A/V), and a TV tuner which are connected with the CPU 100C. The input/output devices for A/V lead to the display 100a. The server 100 also includes a remote control unit 10OR which can communicate with the CPU 100C via a suitable interface. The server 100 (the CPU 100C in the server 100) operates according to an OS such as Linux, and executes application programs. The OS and the application programs are stored in the memory 100M or the hard disk in the drive 100H. Alternatively, the OS and the application programs may be stored in a ROM.

The server 100 acts as a recording and reproducing apparatus including the hard disk drive 100H. The server 100 can record and reproduce contents data on and from the hard disk in the drive 100H. Examples of the contents data are moving picture data (MPEG2 data), still picture data (Bmap data), and audio data (MP3 data). The moving picture data are generated by compressing a TV program signal received by the TV tuner. The still picture data are fed from a digital camera (not shown) via a memory card. The audio data are fed from a music distribution service via the Internet. Alternatively, the audio data can be generated by compressing a digital audio signal, outputted from a home-use CD player, into the MP3 format.

The servers 100 and 101 include interfaces with users. As will be mentioned later, a list of contents represented by data stored in the servers 100 and 101 is indicated by each of the displays 100a and 101a. A user can select one from the contents by actuating the user interface of the server 100 or 101 while referring to the indicated list. The selected content is reproduced by the server 100 or 101. In the case where the data representing the selected content are absent from the server handled by the user, the server gets the data from the other server via the network 10 before reproducing the content represented by the data.

Basic portions of the clients 200 and 201 and the portable digital assistant 202 are similar in structure. Only the basic portion of the client 200 will be described below in detail. As shown in FIG. 3, the client 200 includes a combination of a CPU 200C and a memory 200M. The client 200 further includes decoders for different signal formats, input/output portions of LAN and IrDA types, an interface for a memory card, and input/output devices for audio/visual (A/V) which are connected with the CPU 200C. The input/output devices for A/V lead to the display 200a. The client 200 also includes a remote control unit 200R which can communicate with the CPU 200C via a suitable interface. The client 200 (the CPU 200C in the client 200) operates according to an OS such as Linux, and executes application programs. The OS and the application programs are stored in the memory 200M. Alternatively, the OS and the application programs may be stored in a ROM.

Preferably, the client 200 is an apparatus exclusively for playback which does not have any large-capacity recording medium. An example of the client 200 is an audio visual reproducing apparatus or a television set including an interface with the network 10.

Preferably, the client 201 is a portable audio apparatus exclusively for playback. An example of the client 201 is a portable MD player, a portable CD player, or a portable MP3 player.

The clients 200 and 201 and the portable digital assistant 202 have interfaces with users. Each of the clients 200 and 201 can access contents data in the servers 100 and 101 via the network 10. In response to user's request fed via the user interface, each of the clients 200 and 201 can select one from contents represented by the data in the servers 100 and 101, and can get the selected-content data from the server 100 or 101 and reproduce the selected content. The portable digital assistant 202 can access contents data in the servers 100 and 101 via the wireless LAN access point 301 and the network 10. In response to user's request fed via the user interface, the portable digital assistant 202 can select one from contents represented by the data in the servers 100 and 101, and can get the selected-content data from the server 100 or 101 and reproduce the selected content.

Each of the servers 100 and 101 generates a list of contents represented by data stored therein. The client 200 gets information representative of the contents lists from the servers 100 and 101, and indicates the contents lists on the display 200a. In response to user's request, the client 200 can select one from contents in the indicated lists, and can get the selected-content data from the server 100 or 101 and reproduce the selected content. Similarly, the client 201 gets information representative of the contents lists from the servers 100 and 101, and indicates the contents lists on the display 201a. In response to user's request, the client 201 can select one from contents in the indicated lists, and can get the selected-content data from the server 100 or 101 and reproduce the selected content.

For example, the server 100, the server 101, the client 200, and the client 201 are located in a first living room, a second living room, a study, and a kitchen in a house, respectively. The portable digital assistant 202 can be moved in the house.

In the contents reproducing system or the contents recording and reproducing system of FIG. 1, contents represented by data in the server 100 or 101 can be reproduced by desired one among the servers 100 and 101, the clients 200 and 201, and the portable digital assistant 202. The contents reproducing system or the contents recording and reproducing system has a bookmark providing function for contents on a network. The bookmark providing function makes it possible to watch and listen to a first part of a content on the server 100 and then watch and listen to a subsequent part thereof on the client 200. The bookmark providing function will be mentioned later.

In the contents reproducing system or the contents recording and reproducing system, the servers 100 and 101, the clients 200 and 201, and the portable digital assistant 202 can communicate with each other via the network 10. Different addresses or different ID signals are assigned to the servers 100 and 101, the clients 200 and 201, and the portable digital assistant 202, respectively. Each of the apparatuses 100, 101, 200, 201, and 202 can identify the others by referring to the addresses or the ID signals thereof. Each of the apparatuses 100, 101, 200, 201, and 202 has its own service information. When a first apparatus is requested to communicate with a second apparatus, the first apparatus gets the service information from the second apparatus.

Specifically, the contents reproducing system or the contents recording and reproducing system is designed as a network system based on universal plug and play (Up&p). When the connection of one of the servers 100 and 101, the clients 200 and 201, and the portable digital assistant 202 with the network 10 is established, service discovery is carried out.

The service discovery is as follows. When the connection of an apparatus 100, 101, 200, 201, or 202 with the network 10 is established, the connection-established apparatus transmits its own service information to the other apparatuses via the network 10 on a multicast basis. The service information is carried by a packet signal. While the apparatus remains connected with the network 10, the apparatus repetitively transmits its own service information at a constant time period.

Thus, an apparatus connected with the network 10 transmits its own service information to others connected with the network 10 while receiving service information from each of the others. The apparatus generates a list of apparatuses currently connected with the network 10 in response to the received service information and also its own service information.

The service information about each of the apparatuses 100, 101, 200, 201, and 202 includes information intrinsic to the apparatus such as an IP address, a port number, a MAC address, or a serial number assigned to the apparatus. The service information may include property information having a service type piece representing whether the apparatus is a server providing contents and provided with contents or a client only provided with contents, and a data type piece representing which of moving picture data (MPEG2 data), still picture data (Bmap data), and audio data (MP3 data) the apparatus can handle.

In the contents reproducing system or the contents recording and reproducing system of FIG. 1, the apparatuses 100, 101, 200, 201, and 202 currently connected with the network 10 exchange packet signals (service information) with each other by the service discovery. Each of the apparatuses 100, 101, 200, 201, and 202 generates a list of apparatuses currently connected with the network 10 in response to the service information (the packet signals) transmitted from the other apparatuses and also its own service information.

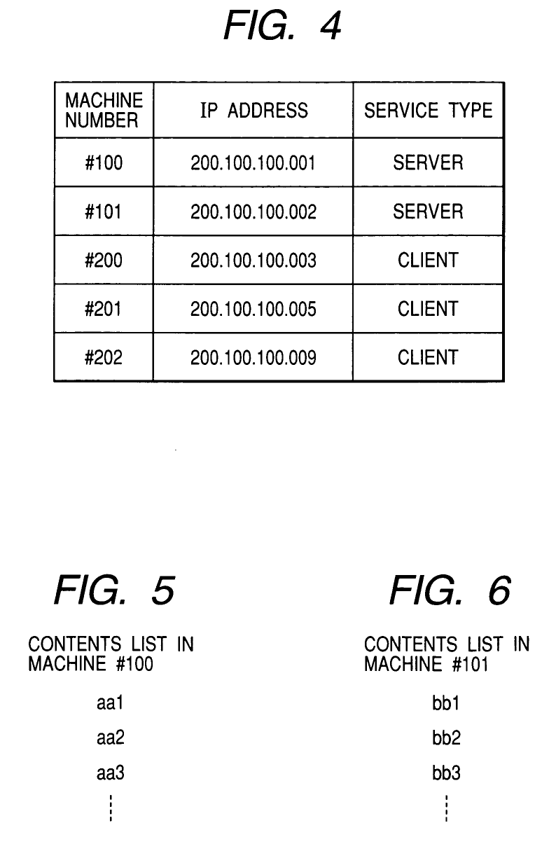

FIG. 4 shows an example of the apparatus list. The apparatus list in FIG. 4 has rows assigned to apparatuses respectively. Each row has a first cell containing a machine number, a second cell containing an IP address, and a third cell containing a service type (a server or a client). The machine number is an ID number of the related apparatus which is formed by the IP address thereof. The service type represents whether the related apparatus operates as a server or a client.

The server 100 generates a list of contents represented by data stored therein. The server 100 stores information representative of the contents list in the memory 100M or the hard disk within the drive 100H. Similarly, the server 101 generates a list of contents represented by data stored therein. The server 101 stores information representative of the contents list in its internal memory or a recording medium within its hard disk drive. After apparatus lists are generated, the servers 100 and 101 exchange signals representative of the contents lists with each other via the network 10. Each of the servers 100 and 101 combines its own contents list and the received contents list into a list of all the contents represented by the data stored in the servers 100 and 101.

As a result of the service discovery, each of the servers 100 and 101 is recognized, by the other apparatuses, to be one able to provide contents. Each of the servers 100 and 101 holds contents data recorded by itself, and also a list of contents represented by the data. Preferably, the contents list in each of the servers 100 and 101 enumerates the titles of respective contents, the addresses of the apparatuses storing data representing the contents, the types of the data representing the contents (the MPEG2 type, the Bmap type, or the MP3 type), and added information pieces relating to the contents. The enumerated items are grouped on a content-by-content basis. The added information pieces represent the names of singers relating to the contents, the names of tunes in the contents, and the genres of the contents.

FIG. 5 shows an example of the contents list in the server 100. The contents list in FIG. 5 indicates characters aa1, aa2, aa3, . . . which denote respective contents represented by data stored in the server 100. For example, the characters aa1, aa2, aa3, . . . express the titles of the respective contents. The contents in the list of FIG. 5 can be reproduced by the server 100.

FIG. 6 shows an example of the contents list in the server 101. The contents list in FIG. 6 indicates characters bb1, bb2, bb3, . . . which denote respective contents represented by data stored in the server 101. For example, the characters bb1, bb2, bb3, . . . express the titles of the respective contents. The contents in the list of FIG. 6 can be reproduced by the server 101.

The contents in the list in the server 100 can also be reproduced by the server 101, the clients 200 and 201, and the portable digital assistant 202. Similarly, the contents in the list in the server 101 can also be reproduced by the server 100, the clients 200 and 201, and the portable digital assistant 202.

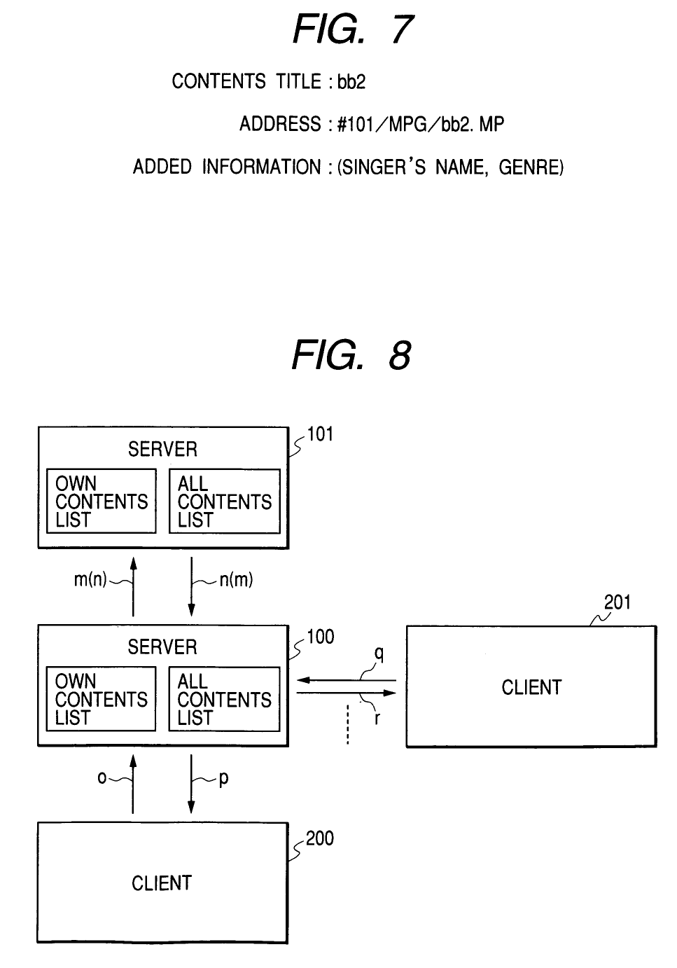

Preferably, the contents data stored in the servers 100 and 101 are in the form of files. The contents are assigned to the files, respectively. As shown in FIG. 7, regarding each content file, there is a correspondence (a correspondence relation) among the title of the content, the address of a place or an apparatus storing the content file, and added information representing the name of a singer relating to the content and the genre of the content. The address of the place or the apparatus storing the content file is composed of the machine number (the IP address) of the apparatus, the directory having the content file, and the name of the content file. The contents lists in the servers 100 and 101 may include sets assigned to the contents respectively and each having the title of the related content, the address of an apparatus storing the file of the related content, and the added information about the related content.

As previously mentioned, the contents in the list in the server 100 can also be reproduced by the other apparatuses. Similarly, the contents in the list in the server 101 can also be reproduced by the other apparatuses. In the case where one of the contents is requested to be reproduced by a destination apparatus, a source apparatus storing the file of the requested content is searched for by referring to the previously-mentioned correspondence relations and then the requested-content file is transmitted from the source apparatus to the destination apparatus. The destination apparatus reproduces the requested content in the received file. To find the source apparatus, the contents lists may be searched.

As a matter of the highest priority, a list of all the contents represented by the data stored in the servers 100 and 101 is generated by combining the contents lists in the servers 100 and 101. By referring to the list of all the contents, not only the servers 100 and 101 but also the clients 200 and 201 and the portable digital assistant 202 can select one among all the contents and reproduce the selected content.

The servers 100 and 101, the clients 200 and 201, and the portable digital assistant 202 operate in accordance with control programs stored in their internal memories or recording mediums in their hard disk drives. The control programs may be stored in ROMs, respectively. The control programs have segments relating to the transmission of contents lists among the apparatuses 100, 101, 200, 201, and 202 and the indication of the contents lists.

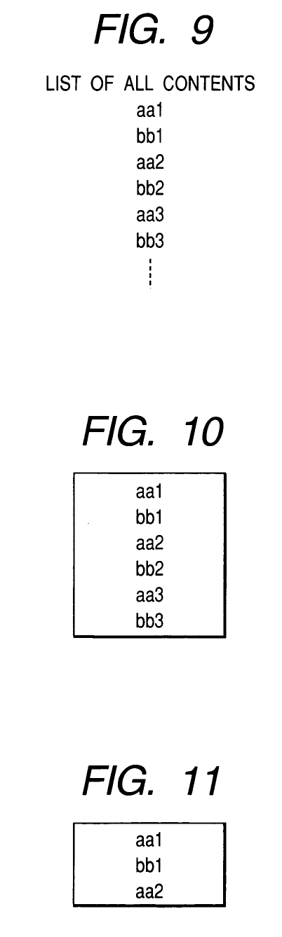

According to the contents-list transmission and indication segments of the control programs, the servers 100 and 101 operate as follows. It is assumed that the server 100 requests the server 101 to provide a content or contents. With reference to FIG. 8, the server 100 transmits a signal “m” representative of a request for a contents list to the server 101 via the network 10. In response to the request signal “m”, the server 101 returns a signal “n” representative of the contents list to the server 100 via the network 10. The server 100 merges the received contents list and its own contents list into a list of all the contents. FIG. 9 shows an example of the list of all the contents. The all contents list in FIG. 9 indicates characters aa1, bb1, aa2, bb2, aa3, bb3, . . . which denote the respective contents represented by the data stored in the servers 100 and 101. The server 100 generates a signal representative of a menu of reproducible contents in accordance with the all contents list. The server 100 feeds the menu signal to the display 100a, and controls the display 100a to indicate the reproducible contents menu. FIG. 10 shows an example of the indicated menu (the indicated all contents list) in which the contents aa1, bb1, aa2, bb2, aa3, and bb3 are enumerated. The user can select one from the contents by actuating the user interface of the server 100 while referring to the indicated all contents list. The server 100 identifies the apparatus, which stores the data representative of the selected content, by referring to the all contents list in response to the selected content. The server 100 decides whether the data representative of the selected content are present therein or absent therefrom on the basis of the identified apparatus. When the data representative of the selected content exist in the server 100, the server 100 reproduces the selected content. In the absence of the data representative of the selected content from the server 100, the server 100 accesses the identified apparatus (the server 101) and gets the data from the server 101 via the network 10 before reproducing the selected content.

It is assumed that the server 101 requests the server 100 to provide a content or contents. With reference to FIG. 8, the server 101 transmits a signal “m” representative of a request for a contents list to the server 100 via the network 10. In response to the request signal “m”, the server 100 returns a signal “n” representative of the contents list to the server 101 via the network 10. The server 101 merges the received contents list and its own contents list into a list of all the contents. The server 101 generates a signal representative of a menu of reproducible contents in accordance with the all contents list. The server 101 feeds the menu signal to the display 101a, and controls the display 100a to indicate the reproducible contents menu (the all contents list). The user can select one from the contents by actuating the user interface of the server 101 while referring to the indicated all contents list. The server 101 identifies the apparatus, which stores the data representative of the selected content, by referring to the all contents list in response to the selected content. The server 101 decides whether the data representative of the selected content are present therein or absent therefrom on the basis of the identified apparatus. When the data representative of the selected content exist in the server 101, the server 101 reproduces the selected content. In the absence of the data representative of the selected content from the server 101, the server 101 accesses the identified apparatus (the server 100) and gets the data from the server 100 via the network 10 before reproducing the selected content.

The control programs for the servers 100 and 101 have segments for updating the contents lists.

According to the contents-list updating segments of the control programs, the servers 100 and 101 operate as follows. It is assumed that the server 101 records data representing a new content. In this case, the server 101 changes its own contents list to include the new content. The server 101 notifies the contents list change to an apparatus, which has previously requested the content list, via the network 10 on a unicast basis. Thus, the server 101 notifies the content list change to the server 100. In response to this notification, the server 100 transmits a signal representative of a request for the contents list (the newest contents list) to the server 101 via the network 10. In response to the request signal, the server 101 returns a signal representative of the contents list (the newest contents list) to the server 100 via the network 10. The server 100 merges the received contents list and its own contents list into a new list of all the contents. The server 100 indicates the new all contents list on the display 100a.

It is assumed that the server 100 records data representing a new content. In this case, the server 100 changes its own contents list to include the new content. The server 100 notifies the contents list change to an apparatus, which has previously requested the content list, via the network 10 on a unicast basis. Thus, the server 100 notifies the content list change to the server 101. In response to this notification, the server 101 transmits a signal representative of a request for the contents list (the newest contents list) to the server 100 via the network 10. In response to the request signal, the server 100 returns a signal representative of the contents list (the newest contents list) to the server 101 via the network 10. The server 101 merges the received contents list and its own contents list into a new list of all the contents. The server 101 indicates the new all contents list on the display 101a.

When the server 101 is disconnected from the network 10, the server 100 does not receive the packet signal of the service information from the server 101. In response to the non-reception of the service information from the server 101, the server 100 removes the server 101 from the apparatus list (see FIG. 4). Furthermore, the server 100 removes the contents represented by the data stored in the server 101 from the all contents list. Therefore, the all contents list in the server 100 changes from the condition of FIG. 9 to the condition of FIG. 5. At the same time, the contents bb1, bb2, and bb3 are removed from the all contents list indicated on the display 100a. Thus, the resultant all contents list indicated on the display 100a enumerates only the contents aa1, aa2, aa3, . . .

When the server 100 is disconnected from the network 10, the server 101 does not receive the packet signal of the service information from the server 100. In response to the non-reception of the service information from the server 100, the server 101 removes the server 100 from the apparatus list. Furthermore, the server 101 removes the contents represented by the data stored in the server 100 from the all contents list. Accordingly, the server 101 changes the all contents list indicated on the display 101a.

As previously mentioned, the client 200 is an apparatus exclusively for playback which does not have any large-capacity recording medium. An example of the client 200 is an audio visual reproducing apparatus or a television set which including an interface with the network 10. The client 200 gets the all contents list from the server 100 or 101. The client 200 utilizes the all contents list in selecting one from all the contents as an object to be reproduced.

According to the contents-list transmission and indication segments of the control programs, the server 100 and the client 200 operate as follows. It is assumed that the client 200 requests the server 100 to provide a content or contents. With reference to FIG. 8, the client 200 transmits a signal “o” representative of a request for the all contents list to the server 100 via the network 10. In response to the request signal “o”, the server 100 returns a signal “p” representative of the all contents list to the client 200 via the network 10. The client 200 indicates at least a portion of the all contents list on the display 200a. FIG. 11 shows an example of the indicated portion of the all contents list in which the contents aa1, bb1, and aa2 are enumerated. The indicated portion can be scrolled. The user can select one from the contents by actuating the user interface of the client 200 while referring to the indicated all contents list. The client 200 identifies the apparatus, which stores the data representative of the selected content, by referring to the all contents list in response to the selected content. The client 200 accesses the identified apparatus (the server 100 or 101) and gets the data representative of the selected content from the identified apparatus via the network 10. The client 200 reproduces the selected content.

The client 200 may filter the all contents list to delete therefrom some of contents unsuited to playback. In the case where the client 200 is a TV set, the client 200 may delete audio contents represented by MP3 data from the all contents list. The client 200 indicates the filtering-resultant all contents list on the display 200a.

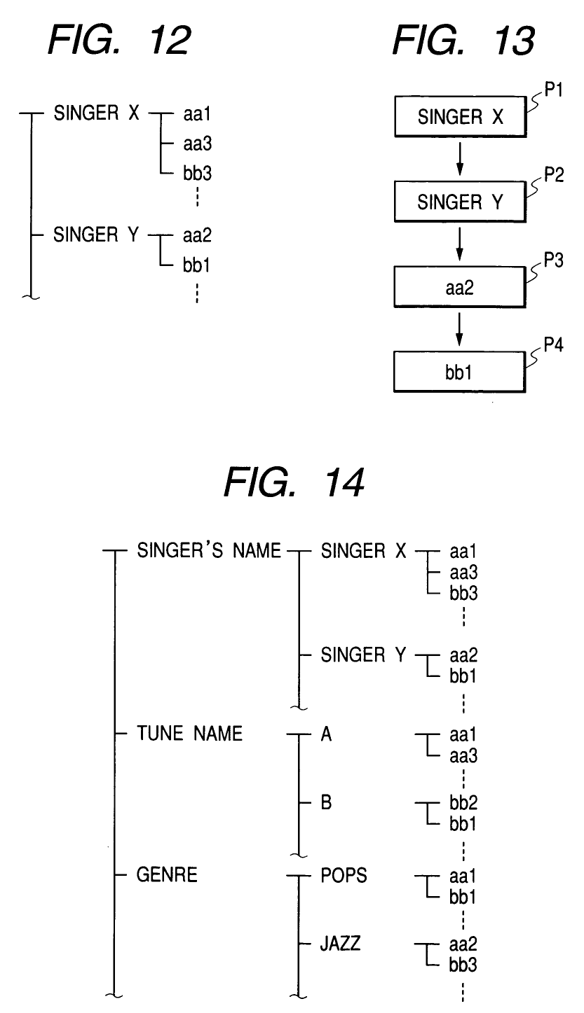

As previously mentioned, each of the servers 100 and 101 generates the all contents list. Each of the servers 100 and 101 may reconstruct the all contents list into a hierarchical form (a tree form). FIG. 12 shows an example of the hierarchical contents list where the contents aa1, bb1, aa2, . . . are sorted with respect to singer. Specifically, the contents are separated into groups assigned to singers “X”, “Y”, . . . respectively. The generation of the hierarchical contents list is allowed on the condition that the contents files have added information representing the names of singers relating to the contents and the genres of the contents (see FIG. 7). Each of the servers 100 and 101 can indicate the hierarchical contents list on its display.

As previously mentioned, an example of the client 201 is a portable audio apparatus exclusively for playback. The display 201a of the client 201 has a size corresponding to, for example, one row. The internal memory in the client 201 has a relatively small capacity. The user interface of the client 201 includes a scroll key and an execution key.

According to the contents-list transmission and indication segments of the control programs, the server 100 and the client 201 operate as follows. It is assumed that the client 201 requests the server 100 to provide a content or contents. With reference to FIG. 8, the client 201 transmits a signal “q” representative of a request for a first unit portion of the hierarchical contents list to the server 100 via the network 10. In response to the request signal “q”, the server 100 returns a signal “r” representative of the first unit portion of the hierarchical contents list to the client 201 via the network 10. The client 201 indicates the first unit portion of the hierarchical contents list on the display 201a. Then, the client 201 transmits a signal “q” representative of a request for the next unit portion of the hierarchical contents list to the server 100 via the network 10. In response to the request signal “q”, the server 100 returns a signal “r” representative of the next unit portion of the hierarchical contents list to the client 201 via the network 10. The client 201 indicates the next unit portion of the hierarchical contents list on the display 201a. Such steps are iterated until one of the contents is selected as an object to be reproduced. FIG. 13 shows an example of pictures P1, P2, P3, and P4 successively indicated on the display 201a. The first picture P1 shows the name of a singer “X” (the first unit portion of the hierarchical contents list). When the client 201 is required to change the singer “X” for another, the picture P1 is replaced by the picture P2 which shows the name of a singer “Y” (the second unit portion of the hierarchical contents list). In the case where the client 201 is informed of the selection of the singer “Y” and is required to indicate a content title, the picture P2 is replaced by the picture P3 which shows the title of the content aa2 relating to the singer “Y” (the third unit portion of the hierarchical contents list). When the client 201 is required to change the content title for another, the picture P3 is replaced by the picture P4 which shows the title of the content bb1 relating to the singer “Y” (the fourth unit portion of the hierarchical contents list). The user can select one from the contents by actuating the user interface of the client 201 while referring to the successively-indicated unit portions of the hierarchical contents list. The client 201 identifies the apparatus, which stores the data representative of the selected content, by referring to the hierarchical contents list in response to the selected content. The client 201 accesses the identified apparatus (the server 100 or 101) and gets the data representative of the selected content from the identified apparatus via the network 10. The client 201 reproduces the selected content.

The hierarchical contents list may be designed as shown in FIG. 14. In the hierarchical contents list of FIG. 14, the contents aa1, bb1, aa2, bb2, . . . are sorted with respect to each of three factors, that is, singer, tune name, and genre.

Each of the servers 100 and 101 may filter the all contents list when receiving a request for the all contents list from the client 200 or 201. For example, the server 100 or 101 deletes, from the all contents list, contents other than audio contents represented by MP3 data when receiving a request for the all contents list from the client which can handle only MP3 data. The server 100 or 101 transmits a signal representative of the filtering-resultant contents list to the client.

The bookmark providing function for contents on a network will be described hereafter. The bookmark providing function makes it possible to watch and listen to a first part of a content on the server 100 and then watch and listen to a subsequent part thereof on the client 200.

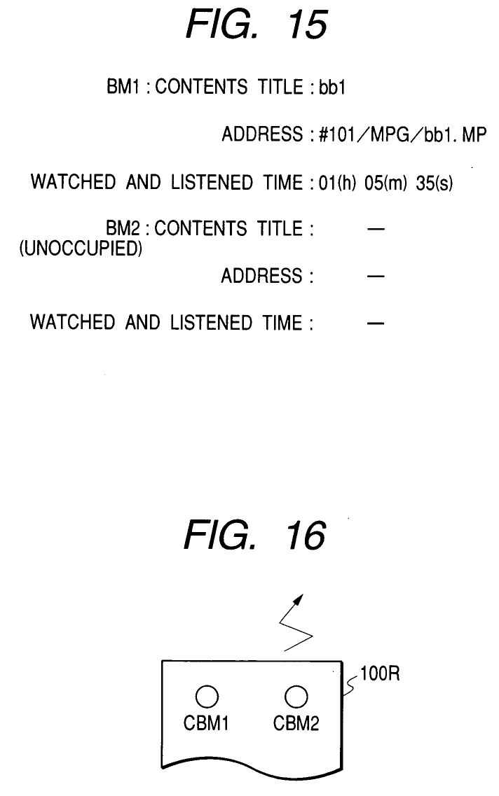

Each of the memory 100M within the server 100, the similar memory within the server 101, the memory 200M within the client 200, and the similar memories within the client 201 and the portable digital assistant 202 has areas for storing signals BM1 and BM2 representing bookmarks. The bookmark signal BM1 and the bookmark signal BM2 are also called the bookmark information BM1 and the bookmark information BM2, respectively. As shown in FIG. 15, each of the bookmark areas is divided into a first segment assigned to a first bookmark signal piece indicating the title of a content, a second segment assigned to a second bookmark signal piece indicating the address of a place (an apparatus) storing the data representative of the content, and a third segment assigned to a third bookmark signal piece indicating a watched and listened time of the content, that is, a bookmark point in the content up to which the content has been watched and listened to.

As shown in FIGS. 2 and 3, the server 100 and the client 200 are equipped with the remote control units 100R and 200R respectively. As shown in FIG. 16, the remote control unit 100R has contents bookmark buttons CBM1 and CBM2 assigned to bookmark signals BM1 and BM2 respectively. The remote control unit 200R has similar contents bookmark buttons.

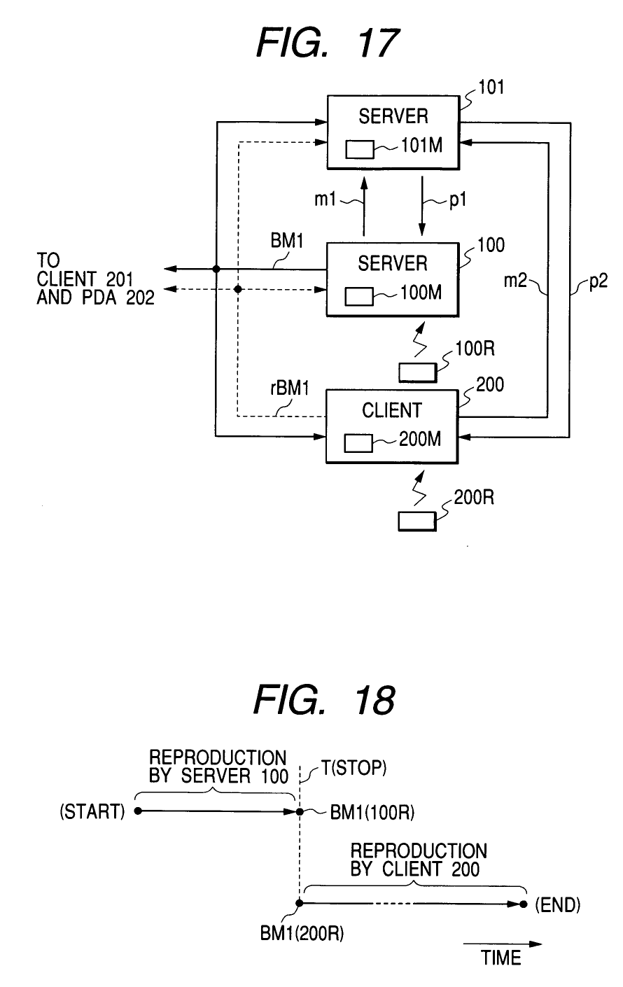

The control programs for the servers 100 and 101 and the client 200 have segments for reproducing a content and providing a bookmark. According to these program segments, the servers 100 and 101 and the client 200 operate as follows. It is assumed that the server 100 is requested to reproduce the content bb1. The server 100 searches the all contents list for the content bb1. As a result of the search, it is found that the data representing the content bb1 exist in the server 101. Thus, as shown in FIG. 17, the server 100 transmits a signal m1 representative of a request for the file of the content bb1 to the server 101 via the network 10. In response to the request signal m1, the server 101 returns a signal p1 representative of the file of the content bb1 to the server 100 via the network 10. The server 100 starts reproducing the content bb1 from its head. Thus, the user can watch and listen to the content bb1 from its head on the server 100. With reference to FIG. 18, as the content bb1 is reproduced, the watched and listened time thereof increases. The server 100 detects the watched and listened time of the content bb1 from the play time thereof.

When the contents bookmark button CBM1 of the remote control unit 100R of the server 100 is depressed (see the moment T in FIG. 18), the remote control unit 100R transmits a signal representative of the depression of the contents bookmark button CBM1 to the CPU 100C of the server 100. In response to the button depression signal, the CPU 100C stops or suspends the reproduction of the content bb1. At the same time, the CPU 100C generates a first bookmark signal piece indicating the title of the content bb1, a second bookmark signal piece indicating the address of the place (the server 101) storing the data representative of the content bb1, and a third bookmark signal piece indicating the watched and listened time of the content bb1, that is, the bookmark point in the content bb1 up to which the content bb1 has been watched and listened to. The CPU 100C combines the first, second, and third pieces into a complete bookmark signal (complete bookmark information) BM1. The CPU 100C writes the bookmark signal BM1 into the corresponding area in the memory 100M of the server 100. At the same time, the server 100 transmits the bookmark signal BM1 to the other apparatuses 101, 200, 201, and 202 via the network 10 on a broadcast basis or a unicast basis. Each of the apparatuses 101, 200, 201, and 202 writes the bookmark signal (the bookmark information) BM1 into the corresponding area in its internal memory.

When the contents bookmark button CBM1 of the remote control unit 200R of the client 200 is depressed, the client 200 reads out the bookmark signal (the bookmark information) BM1 from the corresponding area in the memory 200M. The client 200 refers to the bookmark signal BM1 and thereby identifies a content to be reproduced. Specifically, the client 200 derives the title of a content to be reproduced, that is, the title of the content bb1, from the bookmark signal BM1. In addition, the client 200 derives, from the bookmark signal BM1, the address of the place (the server 101) storing the data representative of the content bb1 and the watched and listened time of the content bb1 (the bookmark point in the content bb1 up to which the content bb1 has been watched and listened to). The client 200 accesses an apparatus at an address equal to the derived address, and requires the accessed apparatus to send the file of the identified content (the content to be reproduced). Specifically, as shown in FIG. 17, the client 200 transmits a signal m2 representative of a request for the file of the content bb1 to the server 101 via the network 10. In response to the request signal m2, the server 101 returns a signal p2 representative of the file of the content bb1 to the client 200 via the network 10. The client 200 starts reproducing the content bb1 from the derived bookmark point (the derived watched and listened time of the content bb1). Thus, the user can watch and listen to the rest of the content bb1 on the client 200. After the bookmark signal BM1 has been used, the client 200 cancels the bookmark signal BM1. Specifically, the client 200 erases the bookmark signal BM1 from the corresponding area in the memory 200M. Furthermore, the client 200 transmits information rBM1 representative of the cancel of the bookmark signal BM1 to the apparatuses 100, 101, 201, and 202 on a broadcast basis or a unicast basis. In response to the bookmark cancel information rBM1, each of the apparatuses 101, 200, 201, and 202 erases the bookmark signal (the bookmark information) BM1 from the corresponding area in its internal memory. Therefore, a bookmark signal BM1 can be used again.

During the reproduction of the content bb1 by the server 100, when the contents bookmark button CBM2 of the remote control unit 100R of the server 100 is depressed, the remote control unit 10OR transmits a signal representative of the depression of the contents bookmark button CBM2 to the CPU 100C of the server 100. In response to the button depression signal, the CPU 100C stops or suspends the reproduction of the content bb1. At the same time, the CPU 100C generates a first bookmark signal piece indicating the title of the content bb1, a second bookmark signal piece indicating the address of the place (the server 101) storing the data representative of the content bb1, and a third bookmark signal piece indicating the watched and listened time of the content bb1, that is, the bookmark point in the content bb1 up to which the content bb1 has been watched and listened to. The CPU 100C combines the first, second, and third pieces into a complete bookmark signal (complete bookmark information) BM2. The CPU 100C writes the bookmark signal BM2 into the corresponding area in the memory 100M of the server 100. At the same time, the server 100 transmits the bookmark signal BM2 to the other apparatuses 101, 200, 201, and 202 via the network 10 on a broadcast basis or a unicast basis. Each of the apparatuses 101, 200, 201, and 202 writes the bookmark signal (the bookmark information) BM2 into the corresponding area in its internal memory.

When the contents bookmark button CBM2 of the remote control unit 200R of the client 200 is depressed, the client 200 reads out the bookmark signal (the bookmark information) BM2 from the corresponding area in the memory 200M. The client 200 refers to the bookmark signal BM2 and thereby identifies a content to be reproduced. Specifically, the client 200 derives the title of a content to be reproduced, that is, the title of the content bb1, from the bookmark signal BM2. In addition, the client 200 derives, from the bookmark signal BM2, the address of the place (the server 101) storing the data representative of the content bb1 and the watched and listened time of the content bb1 (the bookmark point in the content bb1 up to which the content bb1 has been watched and listened to). The client 200 accesses an apparatus at an address equal to the derived address, and requires the accessed apparatus to send the file of the identified content (the content to be reproduced). Specifically, as shown in FIG. 17, the client 200 transmits a signal m2 representative of a request for the file of the content bb1 to the server 101 via the network 10. In response to the request signal m2, the server 101 returns a signal p2 representative of the file of the content bb1 to the client 200 via the network 10. The client 200 starts reproducing the content bb1 from the derived bookmark point (the derived watched and listened time of the content bb1). Thus, the user can watch and listen to the rest of the content bb1 on the client 200. After the bookmark signal BM2 has been used, the client 200 cancels the bookmark signal BM2. Specifically, the client 200 erases the bookmark signal BM2 from the corresponding area in the memory 200M. Furthermore, the client 200 transmits information rBM2 representative of the cancel of the bookmark signal BM2 to the apparatuses 100, 101, 201, and 202 on a broadcast basis or a unicast basis. In response to the bookmark cancel information rBM2, each of the apparatuses 101, 200, 201, and 202 erases the bookmark signal (the bookmark information) BM2 from the corresponding area in its internal memory. Therefore, a bookmark signal BM2 can be used again.

As mentioned above, a bookmark signal (bookmark information) generated by one of apparatuses currently connected with the network 10 is transmitted to the other apparatuses. Thus, the user can watch and listen to a first part of a content on first one of the apparatuses, and then watch and listen to a subsequent part thereof on second one of the apparatuses. It is assumed that the contents bookmark button CBM1 (or CBM2) of the remote control unit 100R of the server 100 is depressed during the reproduction of the content bb1 by the server 100. In this case, a bookmark signal BM1 (or BM2) is generated by the server 100, and is transmitted therefrom to the other apparatuses 101, 200, 201, and 202 on a broadcast basis or a unicast basis as previously mentioned. It should be noted that when the power supply switch of the server 100 which is reproducing a content is changed to its OFF position, a bookmark signal (bookmark information) may be generated by the server 100 regardless of the positions of the contents bookmark buttons CBM1 and CBM2 and be transmitted therefrom to the other apparatuses 101, 200, 201, and 202.

In the case where the contents bookmark button CBM1 is depressed before an already-existing bookmark signal BM1 has not been canceled yet, it is preferable to display that the depression of the contents bookmark button CBM1 is ineffective while the already-existing bookmark signal BM1 remains effective. Alternatively, a new bookmark signal BM1 may be generated in response to the depression of the contents bookmark button CBM1. In this case, the new bookmark signal BM1 replaces the already-existing bookmark signal BM1.

It should be noted that the contents bookmark buttons CBM1 and CBM2 may be assigned to different users respectively.

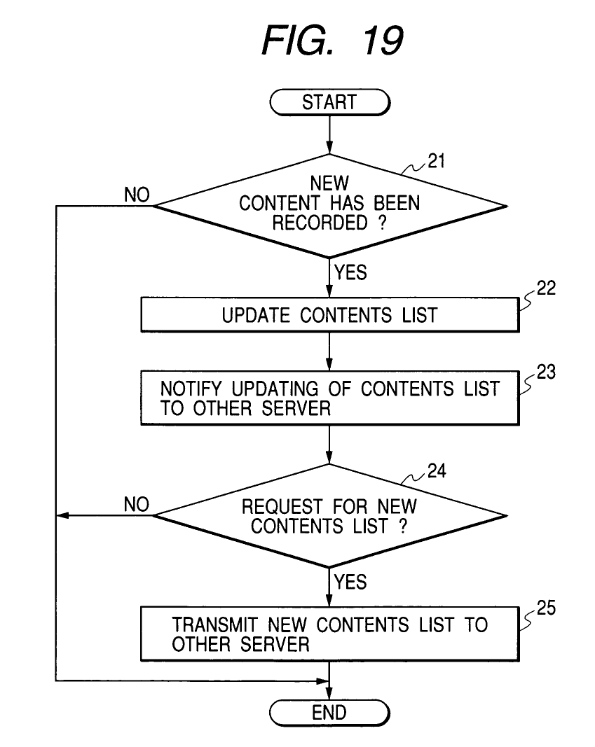

FIG. 19 is a flowchart of a segment of the control program for the server 100 or 101 which relates to the generation and updating of a contents list. The program segment in FIG. 19 is repetitively executed. As shown in FIG. 19, a first step 21 of the program segment decides whether or not data representing a new content have just been recorded in the present server (100 or 101). When data representing a new content have just been recorded, the program advances from the step 21 to a step 22. Otherwise, the program exits from the step 21 and then the current execution cycle of the program segment ends. The step 22 accesses a contents list in the memory within the present server or the recording medium in the hard disk drive within the present server, and updates the contents list to add the new content thereto. A step 23 following the step 22 notifies the updating of the contents list to the other server. A step 24 subsequent to the step 23 decides whether or not a signal representative of a request for the newest contents list has been received from the other server. When the request signal has been received, the program advances from the step 24 to a step 25. Otherwise, the program exits from the step 24 and then the current execution cycle of the program segment ends. The step 25 transmits a signal representative of the newest contents list to the other server. After the step 25, the current execution cycle of the program segment ends.

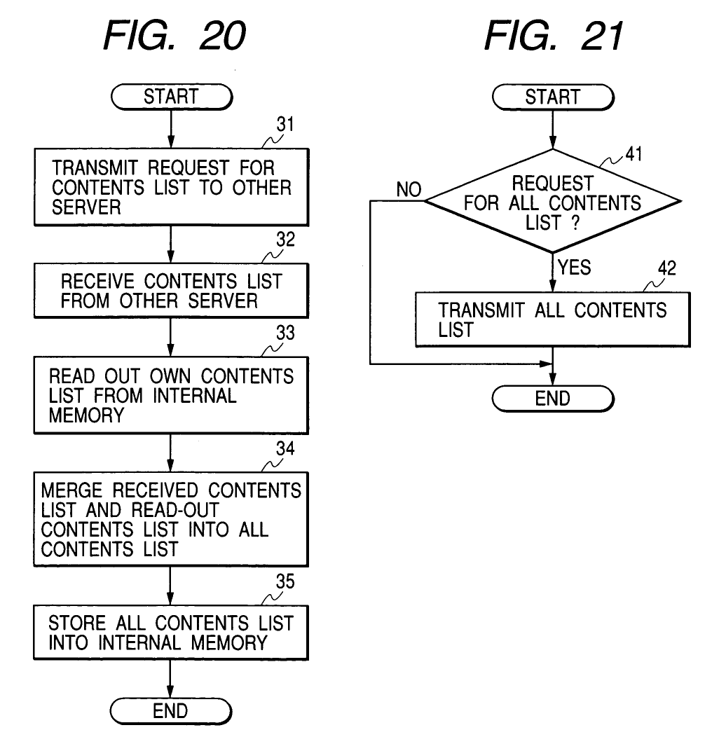

FIG. 20 is a flowchart of a segment of the control program for the server 100 or 101 which relates to the transmission of a contents list and the merger of contents lists. The program segment in FIG. 20 is repetitively executed. As shown in FIG. 20, a first step 31 of the program segment transmits a signal “m” representative of a request for a contents list from the present server to the other server. A step 32 following the step 31 receives the contents list (for example, the newest contents list) from the other server. A step 33 subsequent to the step 32 reads out a contents list from the memory within the present server or the recording medium in the hard disk drive within the present server. A step 34 following the step 33 merges the received contents list and the read-out contents list into an all contents list. A step 35 subsequent to the step 34 stores the all contents list into the memory within the present server or the recording medium in the hard disk drive within the present server. After the step 35, the current execution cycle of the program segment ends.

FIG. 21 is a flowchart of a segment of the control program for the server 100 or 101 which relates to the transmission of an all contents list. The program segment in FIG. 21 is repetitively executed. As shown in FIG. 21, a first step 41 of the program segment decides whether or not a signal representative of a request for the all contents list has just been received. When the request signal has just been received, the program advances from the step 41 to a step 42. Otherwise, the program exits from the step 41 and then the current execution cycle of the program segment ends. The step 42 transmits a signal representative of the all contents list from the present server to an apparatus which requires the all contents list. After the step 42, the current execution cycle of the program segment ends.

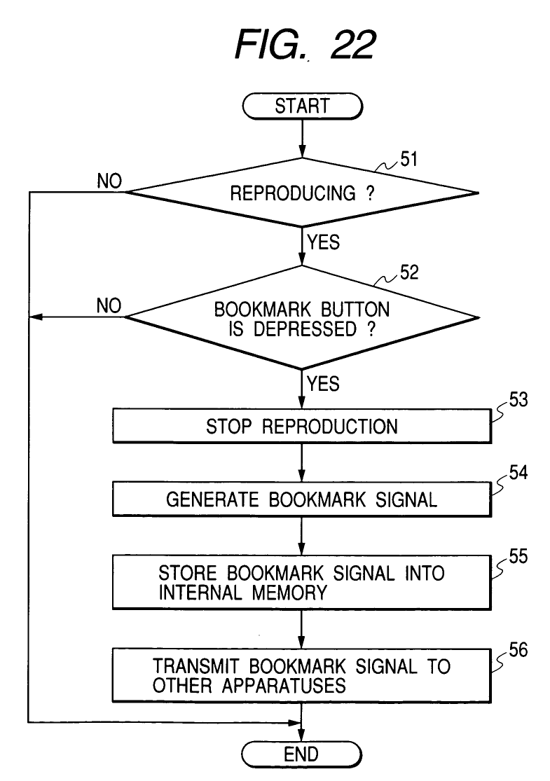

FIG. 22 is a flowchart of a segment of the control program for the apparatus 100, 101, 200, 201, or 202 which relates to the bookmark providing function. The program segment in FIG. 22 is repetitively executed. As shown in FIG. 22, a first step 51 of the program segment decides whether or not the present apparatus is reproducing a content. When the present apparatus is reproducing a content, the program advances from the step 51 to a step 52. Otherwise, the program exits from the step 51 and then the current execution cycle of the program segment ends. The step 52 decides whether or not a contents bookmark button (CBM1 or CBM2) of the remote control unit of the present apparatus is depressed. When the contents bookmark button is depressed, the program advances from the step 52 to a step 53. Otherwise, the program exits from the step 52 and then the current execution cycle of the program segment ends. The step 53 stops or suspends the reproduction of the content. A step 54 following the step 53 generates a first bookmark signal piece indicating the title of the content, a second bookmark signal piece indicating the address of a place (an apparatus) storing the data representative of the content, and a third bookmark signal piece indicating the watched and listened time of the content (the bookmark point in the content up to which the content has been watched and listened to). The step 54 combines the first, second, and third pieces into a complete bookmark signal (complete bookmark information). A step 55 subsequent to the step 54 writes the bookmark signal into the corresponding area in the memory within the present apparatus. A step 56 following the step 55 transmits the bookmark signal from the present apparatus to the other apparatuses. As previously mentioned, each of the other apparatuses writes the bookmark signal into the corresponding area in its internal memory. After the step 56, the current execution cycle of the program segment ends.

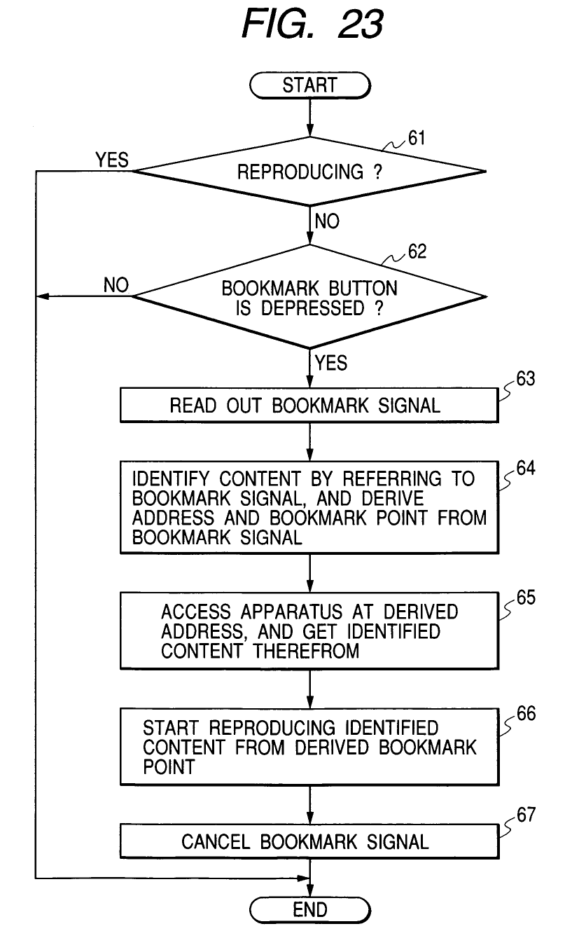

FIG. 23 is a flowchart of a segment of the control program for the apparatus 100, 101, 200, 201, or 202 which relates to the start of content reproduction responsive to a bookmark signal. The program segment in FIG. 23 is repetitively executed. As shown in FIG. 23, a first step 61 of the program segment decides whether or not the present apparatus is reproducing a content. When the present apparatus is reproducing a content, the program exits from the step 61 and then the current execution cycle of the program segment ends. Otherwise, the program advances from the step 61 to a step 62. The step 62 decides whether or not a contents bookmark button (CBM1 or CBM2) of the remote control unit of the present apparatus is depressed. When the contents bookmark button is depressed, the program advances from the step 62 to a step 63. Otherwise, the program exits from the step 62 and then the current execution cycle of the program segment ends. The step 63 reads out a bookmark signal (bookmark information) from the corresponding area in the memory within the present apparatus. A step 64 following the step 63 refers to the read-out bookmark signal and thereby identifies a content to be reproduced. In addition, the step 64 derives, from the bookmark signal, the address of a place (an apparatus) storing the data representative of the identified content and the watched and listened time of the identified content (the bookmark point in the identified content up to which the identified content has been watched and listened to). A step 65 subsequent to the step 64 accesses an apparatus at an address equal to the derived address, and gets therefrom the file of the identified content. A step 66 following the step 65 starts reproducing the identified content from the derived bookmark point (the derived watched and listened time of the content bb1). A step 67 subsequent to the step 66 cancels the bookmark signal. Specifically, the step 67 erases the bookmark signal from the corresponding area in the memory within the present apparatus. Furthermore, the step 67 transmits information representative of the cancel of the bookmark signal to the other apparatuses. After the step 67, the current execution cycle of the program segment ends.

### Advantages Provided by the Invention

The server 100 connected with the network 10 generates a list of contents represented by data stored therein. Also, the server 101 connected with the network 10 generates a list of contents represented by data stored therein. The servers 100 and 101 exchange signals representative of the contents lists with each other via the network 10. Each of the servers 100 and 101 combines its own contents list and the received contents list into a list of all the contents represented by the data stored in the servers 100 and 101. The clients 200 and 201 and the personal digital assistant 202 currently connected with the network 10 can get the all contents list from the server 100 or 101. Thus, each of the clients 200 and 201 and the personal digital assistant 202 can select one from contents by referring to the all contents list, and can reproduce the selected content.

When the reproduction of a content by an apparatus currently connected with the network 10 is suspended, a bookmark signal (bookmark information) is generated. The generated bookmark signal indicates the title of the content, the address of a place (an apparatus) storing the data representative of the content, and the watched and listened time of the content (the bookmark point in the content up to which the content has been watched and listened to). The bookmark signal is transmitted from the apparatus to other apparatuses connected with the network 10. Each of the other apparatuses can start reproducing the content from the bookmark point.

What is claimed is:

1. A contents reproducing system comprising:
first, second, and third apparatuses;
a network connecting the first, second, and third apparatuses;
means provided in the first apparatus for generating a first list of contents represented by data stored in the first apparatus;
means provided in the second apparatus for generating a second list of contents represented by data stored in the second apparatus;
means provided in the first apparatus for getting the second list of contents from the second apparatus and combining the first list of contents and the second list of contents into a third list of contents;
means provided in the second apparatus for getting the first list of contents from the first apparatus and combining the first list of contents and the second list of contents into a fourth list of contents which is equal to the third list of contents; and
means provided in the third apparatus for referring to one of (1) the third list of contents which is generated by the first apparatus and (2) the fourth list of contents which is generated by the second apparatus.

2. A contents reproducing system as recited in claim 1, further comprising:
means provided in the first apparatus for, when data representing a first new content is stored in the first apparatus, updating the first list of contents to include the first new content;
means provided in the second apparatus for, when data representing a second new content is stored in the second apparatus, updating the second list of contents to include the second new content;
means provided in the first apparatus for updating the third list of contents in response to the updating of the first list of contents and the updating of the second list of contents; and
means provided in the second apparatus for updating the fourth list of contents in response to the updating of the first list of contents and the updating of the second list of contents.

3. A contents reproducing system as recited in claim 1, further comprising:
means provided in the first apparatus for, when the second apparatus is disconnected from the network, updating the third list of contents to delete therefrom the contents represented by the data stored in the second apparatus; and
means provided in the second apparatus for, when the first apparatus is disconnected from the network, updating the fourth list of contents to delete therefrom the contents represented by the data stored in the first apparatus.

4. A contents reproducing system comprising:
a first reproducing apparatus;
a second reproducing apparatus;
a network connecting the first reproducing apparatus and the second reproducing apparatus;
first means for, when the first reproducing apparatus suspends reproduction of a content and there occurs an un-reproduced part of the content, generating first information to identify the content, second information to identify a place storing data representing the content, and third information indicating a bookmark point corresponding to a beginning of the un-reproduced part of the content; and
second means for, when the un-reproduced part of the content is requested to be reproduced by the second reproducing apparatus, causing the second reproducing apparatus to identify the content in response to the first information, to get the data representing the identified content from the place identified by the second information, and to reproduce the un-reproduced part of the content in response to the bookmark point indicated by the third information.

5. A contents reproducing apparatus as recited in claim 4, further comprising:
a content bookmark button provided in the first reproducing apparatus;
third means for causing the first reproducing apparatus to suspend the reproduction of the content when the content bookmark button is actuated; and
fourth means for activating the first means when the content bookmark button is actuated.

6. A contents reproducing apparatus as recited in claim 4, further comprising:
a memory provided in the first reproducing apparatus;
third means for combining the first information, the second information, and the third information into bookmark information;
fourth means for writing the bookmark information into the memory; and
fifth means for transmitting the bookmark information to the second reproducing apparatus.

7. A contents recording and reproducing system comprising:
first, second, and third apparatuses;
a network connecting the first, second, and third apparatuses;
means provided in the first apparatus for generating a first list of contents represented by data stored in the first apparatus;
means provided in the second apparatus for generating a second list of contents represented by data stored in the second apparatus;
means provided in the first apparatus for getting the second list of contents from the second apparatus and combining the first list of contents and the second list of contents into a third list of contents;
means provided in the second apparatus for getting the first list of contents from the first apparatus and combining the first list of contents and the second list of contents into a fourth list of contents which is equal to the third list of contents; and
means provided in the third apparatus for referring to one of (1) the third list of contents which is generated by the first apparatus and (2) the fourth list of contents which is generated by the second apparatus.

8. A contents recording and reproducing system comprising:
a first reproducing apparatus;
a second reproducing apparatus;
a network connecting the first reproducing apparatus and the second reproducing apparatus;
first means for, when the first reproducing apparatus suspends reproduction of a content and there occurs an un-reproduced part of the content, generating first information to identify the content, second information to identify a place storing data representing the content, and third information indicating a bookmark point corresponding to a beginning of the un-reproduced part of the content; and
second means for, when the un-reproduced part of the content is requested to be reproduced by the second reproducing apparatus, causing the second reproducing apparatus to identify the content in response to the first information, to get the data representing the identified content from the place identified by the second information, and to reproduce the un-reproduced part of the content in response to the bookmark point indicated by the third information.
